(19) United States
(12) Patent Application Publication
(10) Pub. No.: US 2025/0154985 A1
(43) Pub. Date: May 15, 2025

(54) COMPOSITE BEARING

(71) Applicant: SEAL-RYT CORP., Westfield, MA (US)

(72) Inventor: Mark R. Wilkinson, Huntington, MA (US)

(73) Assignee: SEAL-RYT CORP., Westfield, MA (US)

(21) Appl. No.: 18/940,366

(22) Filed: Nov. 7, 2024

Related U.S. Application Data
(60) Provisional application No. 63/598,088, filed on Nov. 11, 2023.

(51) Int. Cl. F16C 33/04; F16C 33/20

(52) U.S. Cl. CPC F16C 33/046; F16C 33/20; F16C 33/208

(57) ABSTRACT

An improved composite bearing member having at least two distinct surfaces. A first surface having a high CLTE and an opposed dynamic layer of a bearing material having a lower CLTE than the first high CLTE layer. The low CLTE dynamic layer is harder than the static layer to provide a bearing effect. The composite may include a strength layer including carbon fibers having a low CLTE between the high CLTE layer and the lower CLTE harder layer is provided.

### CROSS-REFERENCE TO RELATED APPLICATIONS

This application claims the benefit of U.S. provisional application Ser. No. 63/598,088, filed Nov. 11, 2023, the contents of which are herein incorporated by reference in its entirety.

### BACKGROUND OF THE INVENTION

This invention relates to bearings, and more particularly to a composite or laminate bearing of a combination of at least a first static or expansion surface having a high coefficient of linear thermal expansion (“CLTE”) and an opposed surface of a dynamic bearing material having a lower CLTE than the static material making the bearing particularly well suited for use in fluid sealing systems.

When the temperature of a piece of mechanical equipment including the bearing increases during operation, the static surface expands, urging the opposed dynamic surface into sealing contact with an opposed bearing surface to generate a clamping effect between the dynamic bearing and the bearing surface.

Rotary and reciprocal mechanical devices, such as mixers and centrifugal pumps, include an impeller mounted on a shaft that is driven by a power source, such as an electric motor. The shaft passes through the seal cavity or stuffing box of the device defined by a cylindrical cavity in the device housing. The shaft is supported by bearings at the motor end of the device. Seals are placed in the stuffing box to prevent process fluid from passing through the seal cavity and reaching the bearing and the motor, potentially causing damage to both.

In mechanical pumps, the seal cavity restricts passage of chemical fluids or solvents being pumped, many of which are corrosive. Accordingly, it is important that an appropriate sealing material is placed within the seal cavity. A seal fluid, such as water, may be pumped into the seal cavity through a flush port to prevent the fluid being pumped or mixed from travelling along the shaft to the bearings and motor and to provide lubricant to the rotating shaft. Over extended use, the pump shaft may develop a whip (i.e., lateral or sideways vibration and movement of a rotating shaft as it spins. Shaft whip typically happens when a rotating shaft is not perfectly balanced or experiences other dynamic forces) as the bearings wear. In view of this, it may be desirable to provide a scaling system including a bearing to reduce whip that can occur as the shaft rotates and a lantern ring that provides for increased flush to form an effective seal to limit or at least substantially eliminate an amount of product from entering the seal cavity.

There are a wide variety of shaft sealing systems available. One such commercially successful device is described and claimed in Wilkinson, U.S. Pat. No. 6,834,862 for SHAFT SEALING SYSTEM FOR A ROTARY MECHANICAL DEVICE, issued on Dec. 28, 2004, the contents of which are incorporated herein in its entirety. Here, a bearing with an integral lantern ring provides shaft support, and the lantern ring portion allows for the addition of flush fluid to the seal cavity. Such bearing elements must typically be custom made for a particular application.

Cylindrical bearings are also used in larger size chemical process equipment. For example, a cylindrical bearing formed of a plurality of bearing segments are used as a seal in a pressure diffuser for washing pulp from a digester utilizing a vertically moving screen assembly and a stationary bearing cylinder. The plurality of bearing segments is assembled and mounted onto the moving screen assembly to engage the outer bearing cylinder surface and provide a seal therebetween. Such cylindrical bearings are utilized commercially in pressure diffusers as described in detail in Weston, et al., U.S. Pat. No. 8,157,956 for CYLINDRICAL BEARING FOR PRESSURE DIFFUSER AND ASSOCIATED METHOD, issued on Apr. 12, 2012, the contents of which are incorporated herein by reference in its entirety.

Depending on the height and width of each bearing segment, a plurality of bearing segments can be assembled to form the cylindrical bearing between the moving screen assembly and the fixed bearing cylinder. As described in Weston, et al. at the pulp inlet, a first annular section formed of a hard bearing material is mounted to the screen assembly and a second annular section formed of a softer material is mounted above or downstream of the hard sections. Such cylindrical bearings may be used in a variety of applications. The first hard bearing segments described in Weston et al. are formed of bearing materials of the type suitable for use in the Wilkinson, U.S. Pat. No. 6,834,862. When used in this arrangement of the type of vertical placement of a first bearing grade material and a second softer material disposed above and adjacent to the bearing grade material, the two sets of cylindrical bearing segments provide for extended use over earlier generations of bearings for this use. The earlier generation of bearings were generally formed only of the soft material utilized for the second annular bearing segments.

While these solutions are highly acceptable for many applications, it is desirable to provide additional sealing solutions that are effective for greater periods of time compared to bearings currently available. Extended use is desirable as this extends process life without having to shut down an entire process to replace worn bearings.

### SUMMARY OF THE INVENTION

Generally speaking, in accordance with the invention, an improved composite bearing formed of at least two distinct materials is provided. The composite bearing is a unitary body having a first static expansion surface material having a high CLTE and a second opposed dynamic surface material of a hard bearing grade material having a lower CLTE than the static high CLTE material. The low CLTE bearing material is harder than the first static material and is suitable to provide a bearing effect. The composite may include a middle strength or reinforcing layer having a lower CLTE than both the high CLTE static surface and the bearing surface materials The static and dynamic surface materials and the strength layer typically includes fillers, such as graphite, carbon or glass fibers or impregnated fiber sheets to impart additional strength to the composite bearing.

The composite bearings in accordance with the invention may be formed by compression molding the desired materials in a mold while applying sufficient heat and pressure to fuse the layers together to yield a unitary composite bearing member of desired properties. Generally, temperatures are greater than the softening point of the selected materials and under pressure of the mold ensure bonding between the layers of materials that make up the composite. The molds used to form the bearing segments may be curved in desired dimensions and a radius so that molded segments of the composite members may be placed adjacent to each other to provide a cylindrical form suitable for use as a bearing.

Each of the surface layers and the reinforcing layer for forming the composite bearing in accordance with the invention may be formed from chopped or continuous fiber reinforced thermoplastics. The individual layers of materials may be formed from sheets or fabrics with the selected polymers melted on and then fully impregnated under pressure and elevated temperatures. Alternatively, the layers may be formed in situ with powdered materials.

An adhesive, a primer, or other material may be added to a surface of one or more of the first high CLTE static surface material, the strength layer and the lower CLTE dynamic surface material to assist in the bonding of the various materials into a unitary member able to provide a bearing effect. In addition, the composites and bearings may be formed by additive manufacturing techniques such as 3D Printing, Rapid Prototyping (RP), Direct Digital Manufacturing (DDM), layered manufacturing and additive fabrication. In this process, 3D objects are built by adding layer-upon-layer of material, whether plastic, neat or filled, and metal.

The molded composites are suitable for sealing and providing a sealing and bearing surface for a wide variety of end uses, including pressure diffusers as described in detail in Weston et al., U.S. Pat. No. 8,157,956.

Accordingly, it is an object of the invention to provide an improved bearing for sealing a mechanical device.

It is another object of the invention to provide an improved composite bearing for a mechanical device.

A further object of the invention is to provide an improved composite bearing having a first static surface layer having a high CLTE and an opposed second dynamic surface layer of a bearing material having a lower CLTE than the first static layer and harder than the first static surface material.

Yet another object of the invention is to provide an improved composite bearing comprising a static surface layer having a high CLTE bonded to one face of a middle strength layer and a dynamic surface layer of a bearing material having a lower CLTE than the first layer and harder than the first layer bonded to the opposite face of the strength layer to form a unitary bearing or bearing segment.

Still another object of the invention is to provide a method of forming a composite bearing or bearing segment having a first static surface layer having a high CLTE and a second dynamic surface layer of a bearing material having a lower CLTE than the first static layer and harder than the first static layer.

Still a further object of the invention is to provide a method of forming a composite bearing or bearing segment by compression molding.

Still a further object of the invention is to provide a method of forming a composite bearing or bearing segment by additive manufacturing.

Yet another object of the invention is to provide a composite bearing with at least three layers including a first static layer having a high CLTE, a second reinforcing layer bonded to a first face of the first layer; and a dynamic layer of a bearing material having a lower CLTE than the first layer and harder than the first layer bonded to the opposite face of the strength layer to form a unitary composite bearing member.

Still other objects and advantages of the invention will in part be obvious and will in part be apparent from the specification.

The invention comprises a product possessing the features, properties, and the relation of components and a method for manufacture which will be exemplified in the product hereinafter described and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1 is a perspective view of a composite bearing segment having a static surface having a high CLTE and an opposed dynamic bearing surface having a CLTE lower than the static surface in accordance with the invention;

FIG. 2 is a perspective view of a composite bearing segment of the type suitable for forming a circular bearing as shown in FIG. 5 in accordance with the invention;

FIG. 3 is a cross-sectional view of a two-layer version of the composite bearing segment of FIG. 2 showing a static expansion surface layer bonded to a dynamic bearing surface layer forming a circular bearing segment in accordance with the invention;

FIG. 4 is a cross-sectional view of a three-layer version of the composite bearing segment of FIG. 2 with an outer static expansion surface layer on one face of a middle strength or reinforcing layer and a dynamic bearing surface layer on an opposed face of the strength layer in accordance with the invention;

FIG. 5 shows twelve bearing segments shown in FIGS. 2-4 for forming a 90-inch diameter circular bearing for installation in a pressure diffuser of the type shown in FIG. 6 in accordance with the invention;

FIG. 6 is a cross-sectional view of an exemplary variable pressure diffuser used in a pulp mill including the segmented bearing segments of the type shown in FIGS. 2-4 in accordance with the invention;

FIG. 7 is an exploded view of a section of the pressure diffuser of FIG. 6 showing placement of the circular bearing at the inlet between the moveable screen assembly and the stationary bearing cylinder of the pressure diffuser of FIG. 6;

FIG. 8A is a perspective view of a split cylindrical composite bearing having a static surface the outer surface of the bearing and a dynamic bearing surface layer on the opposed inner surface of the bearing in accordance with the invention suitable for use in rotating or reciprocating shaft equipment;

FIG. 8B is a cross-sectional view of one-half of the split cylindrical bearing of the composite bearing of FIG. 8A in accordance with the invention;

FIG. 9A is a perspective view of a split cylindrical composite bearing with an integral lantern ring and formed with an outer static surface on one face of a reinforcing layer and a inner dynamic bearing surface layer on the opposed face of the reinforcing layer in accordance with the invention suitable for use in rotating or reciprocating shaft equipment;

FIG. 9B is a cross-sectional view of one-half of the split cylindrical bearing with an integral lantern ring of the composite bearing of FIG. 9A in accordance with the invention;

FIG. 10 is a cross-sectional view showing a composite bearing segment with a static surface layer to be mounted on a stationary bearing cylinder of the pressure diffuser of FIG. 6 and a dynamic bearing surface layer having a larger radius for contacting the moving screen assembly in accordance with another embodiment of the invention;

FIG. 11 is a front perspective view showing the dynamic surface of a composite bearing segment having reinforced top and bottom edges in accordance with a further embodiment of the invention; and

FIG. 12 is a perspective view showing the edge reinforcement of the dynamic surface of the composite bearing section of FIG. 11 in accordance with the invention.

### DESCRIPTION OF THE PREFERRED EMBODIMENTS

As used herein, “a,” “an,” and “the” refer to both singular and plural referents unless the context clearly dictates otherwise.

As used herein, the terms “about” and “approximately” refer to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the invention described herein. Furthermore, it is also to be understood that the value to which the modifiers “about” and “approximately” refer are themselves specifically disclosed herein.

As used herein, spatially relative terms, such as “beneath,” “below,” “lower,” “above,” “upper” and the like, are used for ease of description to describe one element or feature's relationship to another element(s) or feature(s) as illustrated in the figures. It is further understood that the terms “front” and “back” are not intended to be limiting and are intended to be interchangeable where appropriate.

As used herein, the terms “comprises” and/or “comprising,” specify the presence of stated features, integers, steps, operations, elements, and/or components, but do not preclude the presence or addition of one or more other features, integers, steps, operations, elements, components, and/or groups thereof.

All amounts are percent by weight unless otherwise noted. All numerical ranges are inclusive and combinable in any order except where it is logical that such numerical ranges are constrained to add up to 100%. The term “average” is equivalent to the mean value of a sample.

As described herein, a composite bearing in accordance with one embodiment of the invention is a unitary body having a first static expansion surface material having a high CLTE and a second opposed dynamic surface material of a hard bearing grade material having a lower CLTE than the static high CLTE material. The low CLTE bearing material is harder than the first static material and is suitable to provide a bearing effect. The composite bearing may include a middle strength or reinforcing layer having a lower CLTE than both the high CLTE static surface and the bearing surface. The static and dynamic surfaces and the strength layer may include fillers, such as graphite, carbon or glass fibers or impregnated sheets to impart additional strength to the composite bearing. Such composite bearing segments are substantially stable in the x, y planes.

In one preferred embodiment, the present invention relates generally to a composite bearing comprising:
a bearing member having a first static surface layer with a high coefficient of thermal linear expansion (“CLTE”); and
an opposed second dynamic surface layer of a bearing grade material having a lower CLTE than the first static surface and harder than the first surface.

In another preferred embodiment, the present invention also relates generally to a composite bearing member formed of at least three distinct materials comprising:
a reinforcing layer having two faces;
a static surface layer having a high coefficient of thermal linear expansion (“CLTE”) on one face of the reinforcing layer; and
a dynamic surface layer of a bearing grade material having a lower CLTE than the static layer and harder than the static layer on the opposite surface of the reinforcing layer

In another preferred embodiment of the invention, the composite bearings include a mid-layer high-strength reinforced material having a CLTE lower than both the dynamic bearing and static layers with the static surface on one face and the dynamic surface on the opposed face.

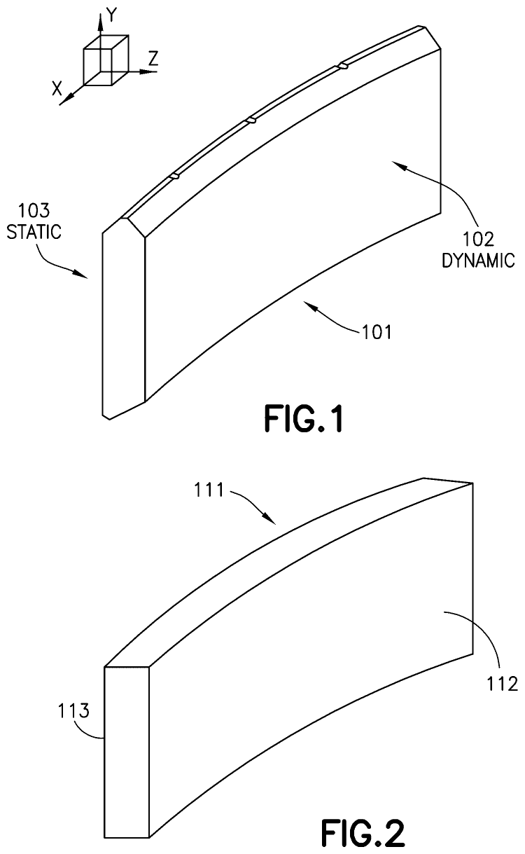

FIG. 1 illustrates a composite bearing segment 101 prepared in accordance with one aspect of the invention. Bearing 101 is a compression molded composite bearing segment having a dynamic bearing surface 102 and an opposed static expansion surface 103. During operation of equipment as the temperature rises, static surface 103 having a higher CLTE expands in the z-direction urging the harder dynamic surface 102 towards a friction surface thereby sealing the space between two friction surfaces. Both static surface 103 and dynamic surface 102 are dimensionally stable in the x and y-direction once installed.

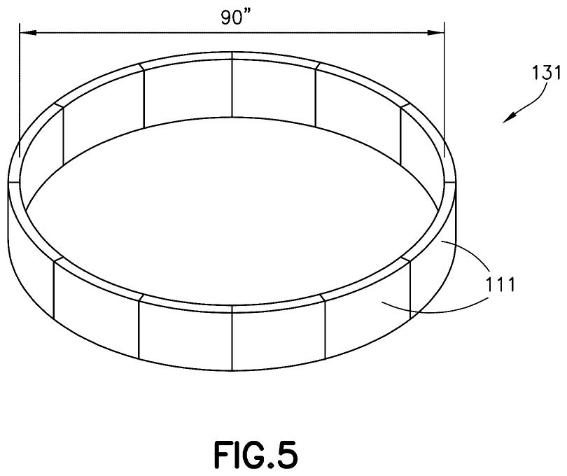

FIG. 2 is a perspective of a bearing segment 111 in accordance with another aspect of the invention having a dynamic surface 112 and a static surface 113 and formed with a desired radius so that when a plurality of segments 111 are vertically aligned next to each other they will form a cylinder 131 as shown in FIG. 5.

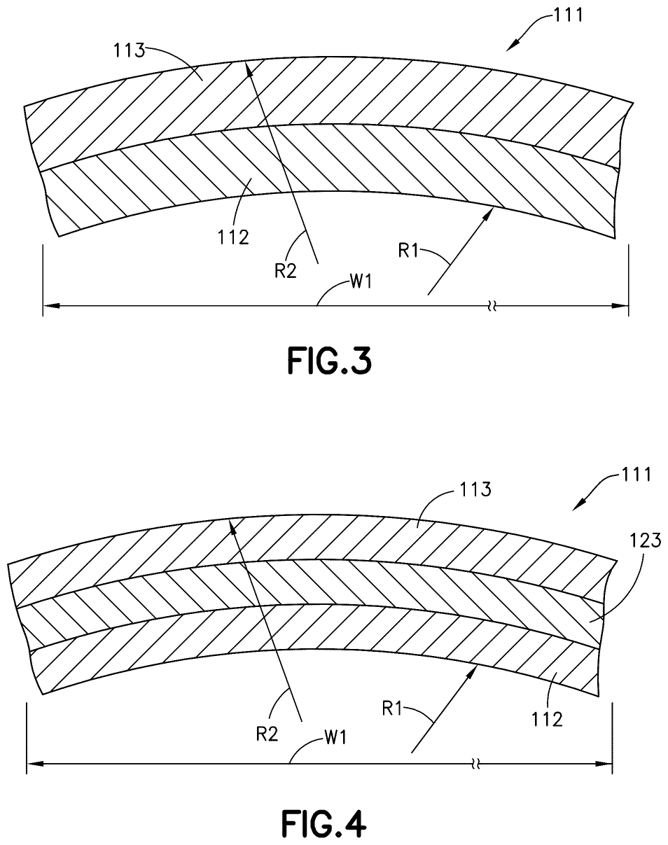

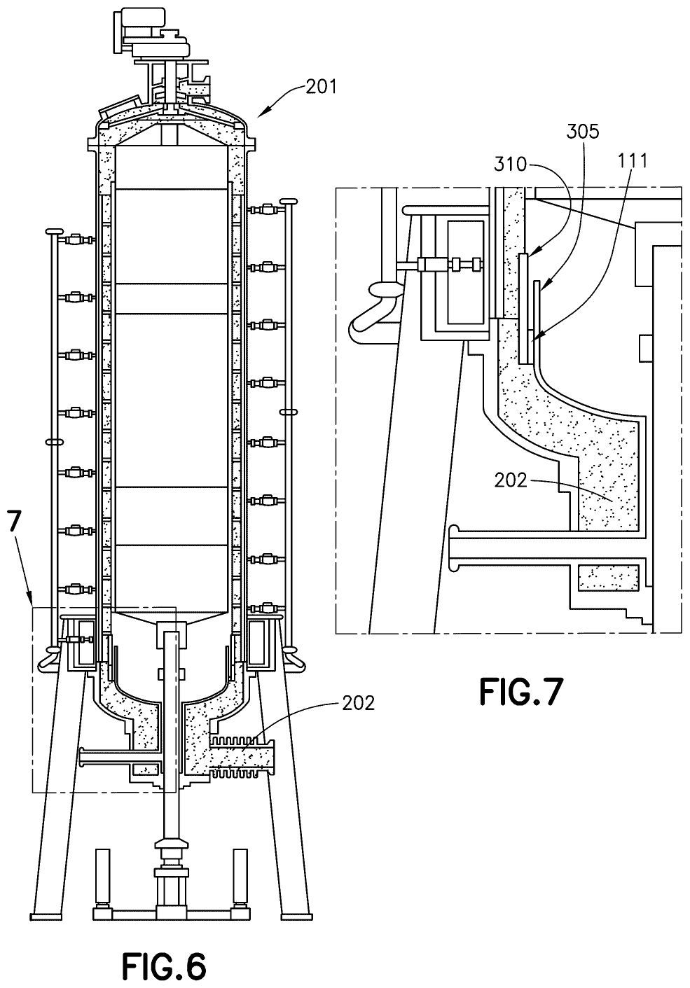

As shown in cross-section in FIG. 3, bearing segment 111 may have dynamic surface layer 112 having a radius R1 bonded directly to static surface layer 113 having a larger radius R2 than dynamic surface layer 112. FIG. 4 is a cross-section of bearing segment 111, similar to bearing segment 111 but including a mid-strength and reinforcing layer 123 arranged between the dynamic surface layer 112 and the static surface layer 113. As will be described in more detail below, cylindrical bearing 111 is particularly well suited for use in large mechanical process equipment, such as a pressure diffuser 201 shown in FIG. 6 for washing pulp in a pulp mill.

In the illustrated embodiment in FIG. 6, pressure diffuser 201 used to wash an inlet stream of pulp 202 exiting a digester is one of the pieces in a typical pulp mill. For a detailed description of the operation of pressure diffuser 201 reference again is made to Weston, et al., U.S. Pat. No. 8,157,956, the contents of which are incorporated herein by reference in its entirety.

Here, hot pulp stream 202 from a digester, typically between 180-200° F. (but may be higher in some cases) and 60 psi, enters the bottom of pressure diffuser 201 and makes its way upward to the top of diffuser 201 where it exits. All along the way, pulp 202 is washed with clean filtrate. FIG. 7 is an exploded view of FIG. 6 and illustrates a section of the lower portion of FIG. 6. The extracted dirty filtrate moves through the holes of the extraction screen and is discharged at the bottom. Pulp 202 entering diffuser 201 typically includes chemicals (i.e., white liquor residual from the cooking process) and may have solid tramp material such as rocks, stones, glass bits, and metal chards. These solid contaminants can cause wear and gouge to the scaling/bearing members, limiting the sealing life of the bearings used to seal. As can be seen in FIG. 7, bearing segments 111 are mounted on the interior of a moveable screen assembly 310 and engage a bearing cylinder 305.

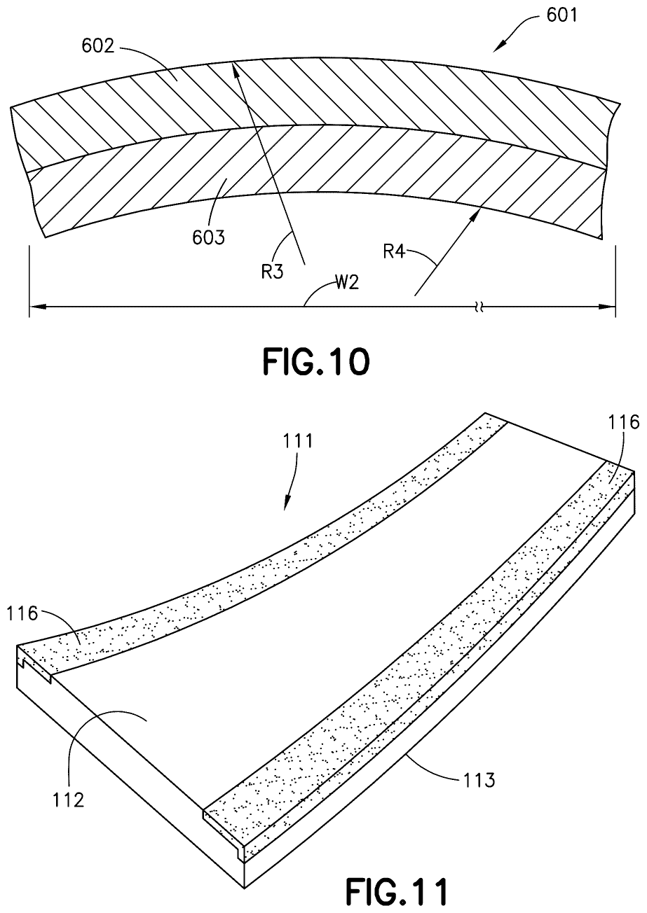

FIG. 10 is a cross-sectional view of an alternative embodiment that can be mounted on stationary bearing cylinder 305 of pressure diffuser 201 of FIG. 6 for contacting moving screen assembly 310. Here, a composite bearing segment 601 with a dynamic surface layer 602 having a radius R3 slightly shorter than radius R2 of static surface 113 of FIG. 3 contacts moving screen assembly 310 and a static surface having a radius R4 slightly shorter than radius R1 of a dynamic surface layer 112 of FIG. 2 that is mounted on bearing cylinder 305.

As shown in the bearing segments in cross-section in FIGS. 3 and 4, bearing segments 111 each have a width W, an inner radius R1 and an outer radius R2. This allows bearing segment 111 to be used to form a large diameter cylindrical bearing 131 as shown in FIG. 5. For a 90-inch diameter pressure diffuser, there are typically twelve curved segments each approximately 24 inches wide. Of course, if a different size pressure diffuser is used or the segments have a different width, a different number of bearing segments 111 may be vertically aligned next to each other to form cylindrical bearing 131.

As described herein, composite bearings in accordance with the invention may be formed by compression molding the desired materials in a mold while applying sufficient heat and pressure to fuse the layers together to yield a unitary composite bearing member of desired properties. Generally, temperatures are greater than the softening point of the selected materials and under pressure of the mold ensure bonding between the impregnated sheets of materials that make up the composite. The molds used to form the bearing segments are curved in desired dimensions and a radius so that molded segments of the composite members may be vertically aligned next to each other to provide a cylindrical form suitable for use as a bearing. The pressure used to ensure bonding between the sheets of materials is sufficient to assure adhesion and bonding between the selected impregnated sheets of materials.

Referring to bearing segment 111 of FIG. 4, an adhesive, a primer, or other material may be added to a surface of one or more of static surface layer 113, reinforcing mid-layer 123, and the lower CLTE dynamic surface layer 112 to assist in the bonding of the various polymer impregnated sheets of materials into a unitary member that can provide a bearing effect.

Each material selected for the composite must be compatible and allow formation of a unitary structure upon application of sufficient heat and pressure. In addition, material selected for the composite must be capable of providing a suitable bearing surface and must be chemically resistant to corrosive fluids and other industrial solutions. The static or expansion layer may be formed of a polytetrafluoroethylene (PTFE) material or blend that is relatively soft compared to the opposed wear or bearing layer. For example, the static or expansion layer may have a Shore D hardness of between about 60-75. The material of the static or expansion layer preferably has a thermal coefficient of linear expansion (“CLTE”) several orders of magnitude greater than the CLTE of the equipment and the opposed wear or bearing surface. The expansion layer can expand in the z-direction to urge the dynamic wear layer towards the stationary bearing cylinder. This causes the wear layer to form a seal against the bearing cylinder, closing the gap to prevent solid contaminants such as fibers from the pulp and tramp material from migrating through the gap and into the filtrate chamber within the pressure diffuser.

Thermal expansion is defined as the tendency of a material to change its shape, area, and density in response to a change in temperature, usually not including phase transitions. The coefficient of linear thermal expansion, or CLTE is referred to as α, is the linear expansion per unit length divided by the change in temperature, or α=ΔL/(L0*ΔT). PTFE materials such as Rulon® PTFE (a family of PTFE plastics with low coefficient of friction by Saint-Gobain) are utilized in many pressure diffuser applications as they have CLTEs several orders of magnitude, e.g., at least ten times greater than the metals forming the devices. This allows the Rulon® PTFE to expand at elevated operating temperatures and form a seal between the metal elements of the device. As described in Weston, et al. U.S. Pat. No. 8,157,956, the Rulon® PTFE is usable in combination with segments of harder bearing grade material having a lower CLTE that does not gouge due to impurities in the pulp feed. The harder and lower CLTE material is positioned to face the pulp feed, and the softer material is seated on the upper edge of the harder bearing material to seal any solid contaminants such as fibers from the pulp and tramp material from passing the bearing section.

Materials are selected that can provide a suitable dynamic bearing surface and that are resistant to most industrial solutions, including corrosive materials. Suitable bearing materials are those that provide suitable chemical, temperature, compressive strength, flexural strength, and wear characteristics and can be appropriately machined to yield the desired bearing dimensions and tolerances. Such bearing materials include, but are not limited to, polymers, including polyphenylene sulfides (PPS), polyimidizoles, polyamideimides, polybenzylimidizoles, polyketones, polyaryletherketones, such as polyetheretherketone (PEEK), polytetrafluoroethylene (PTFE), perfluoroalkoxy alkane (PFA), other fluoropolymers and formulations containing these polymers in a major proportion.

In one embodiment, static surface layer 113 is a fluoropolymer such as PTFE, PFA or other similar fluoropolymer based material. These materials are relatively soft compared to the opposed bearing or wear surface. Typically, the CLTE of static surface layer 113 is between 50 μm/(m·° F.) to 110 μm/(m·° F.), and preferably between 70 μm/(m·° F.) and 95 μm/(m·° F.).

Dynamic surface layer 112 is one that is compatible with static surface layer 113, a reinforcing mid-layer 123 in a three-layer composite that can be a carbon fiber filled material such as a polyphenylene sulfide. Dynamic surface layer 112 will have a CLTE lower than static surface layer 113, for example from about 20 μm/(m·° F.) to 60 μm/(m·° F.) and preferably between 30 μm/(m·° F.) and 40 μm/(m·° F.).

Reinforcing mid-layer 123 is compatible with both static surface layer 113 and dynamic surface layer 112 and preferably contains a strength or reinforcing material disposed therein. In one embodiment, the strength or reinforcing material comprises a filler such as graphite, carbon or glass fibers, or impregnated sheets by way of example and not limitation. In one embodiment, the reinforcing material comprises carbon fibers and the reinforcing mid-layer 124 can be a highly carbon fiber filled material, such as carbon-fiber reinforced polyphenylene sulfide (PPS-CF). Generally, reinforcing mid-layer 123 will have a CLTE comparable or slightly lower than dynamic surface layer 112, for example about 15 μm/(m·° F.) to 45 μm/(m·° F.) and preferably between 25 μm/(m·° F.) and 35 μm/(m·° F.).

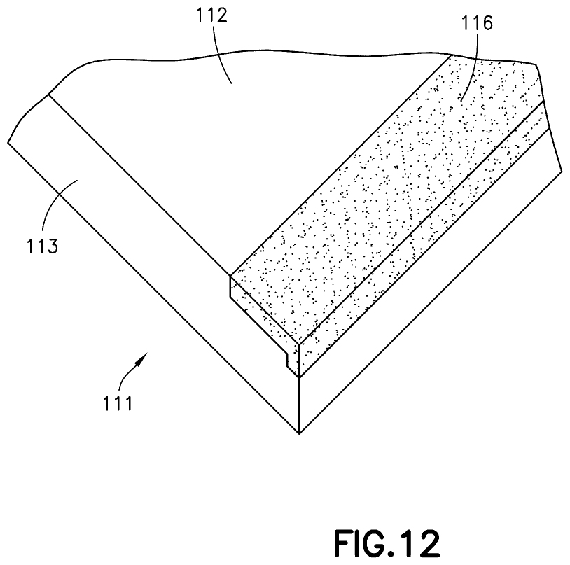

FIGS. 11 and 12 illustrates an embodiment of the invention wherein bearing segment 111 includes dynamic surface layer 112 and static surface layer 113 bonded to opposite faces of reinforcing layer 123 as shown in FIG. 4. Bearing segment 111 is modified to include a thin edge protection layer 116 at the lower and upper edges of bearing segment 111 formed by extending reinforcing layer material 123 over a portion of bearing layer 112 to protect the edges of bearing segment 111 during the up and down strokes of screen assembly 310 of pressure diffuser 201.

The following Example is set forth by way of illustration to help explain the invention and is not intended to be limiting in any way.

### Example 1

An evaluation was performed of the composite material prepared for installation in an inlet device for a 90-inch pressure diffuser of the type described in U.S. Pat. No. 8,157,956 and shown in FIGS. 6 and 7. Twelve curved plates approximately 24 inches wide, 8 inches high and 0.75 inch thick having an inner radius of approximately 43 inches prepared by compression molding the layers of selected materials at sufficient heat and pressure to fuse the three composite layers of the composite together.

In this Example, each bearing segment 111 included three layers, each approximately 0.25 inch in thickness as shown in FIG. 4. The first static expansion layer is a polytetrafluoroethylene material having a high CLTE of about 83 μm/(m·° F.), an intermediate reinforcing layer of a PPS-CF polymer thereon and finally a dynamic bearing grade layer of polyphenylene sulfide polymer on the opposed surface of the reinforcing layer.

The composite material was installed in the inlet device of a 90-inch pressure diffuser and subjected to normal use for a period which consisted of about two years.

The three-layer composite bearing in accordance with the invention was removed from service after almost one year and showed only slight service scoring with no deep gouges, indicating that the bearing segments had substantial additional useful life. In contrast, bearings having a first ring of a hard material and an adjacent ring of soft material of the type described in U.S. Pat. No. 8,157,956 typically must be replaced within about one year in service. It is anticipated the composite bearings in accordance with the invention will perform to very high standards for at least 3 years in the worst conditions and more than 5 years in average conditions and provide exceptional economic returns over all other currently available sealing mechanisms. The composite bearing by virtue of its intimacy with the cylinder as well as its material stability has shown greatly reduced wear to the bearing cylinder. This is significant because the cylinder sleeve is Titanium and that it is extremely expensive. The attributes mentioned ensure that large particle tramp material does not enter the sealing interface, which is what causes current standard technologies to fail early as large particles groove the softer sealing material and then are held by it against the sealing surface thus damaging the Titanium sleeve.

In another embodiment, each bearing segment of the composite bearings described herein may be formed by additive manufacturing techniques such as 3D Printing, Rapid Prototyping (RP), Direct Digital Manufacturing (DDM), layered manufacturing and additive fabrication. In this process, 3D objects are built by adding in a stepwise fashion, layer-upon-layer of material, whether plastic, neat or filled, and metal. For example, each of static surface layer 113, dynamic surface layer 112, and reinforcing mid-layer 123 of bearing segment 111 may be separately fabricated through various additive manufacturing techniques to have a desired CLTE as described above and other desirable properties. Alternatively, the various layers (i.e., static surface layer 113, dynamic surface layer 112, and reinforcing mid-layer 123) of bearing segment 111 may be manufactured in one step to produce a bearing segment in which the bearing segment has the desired CLTE for each surface thereof. In still another embodiment, the composite bearing may be formed by additive manufacturing in one step so that the bearing has the desired CLTE for each surface thereof.

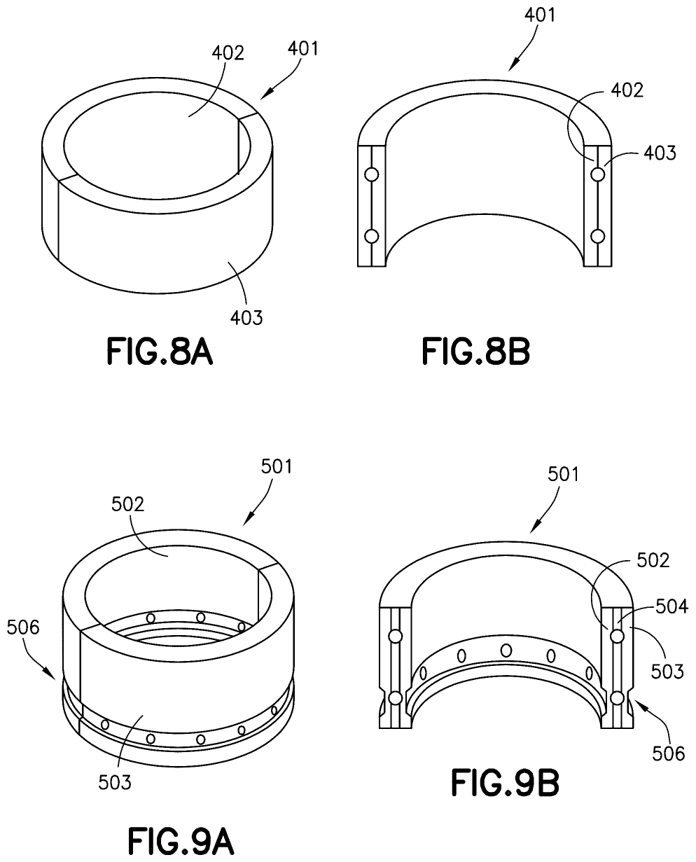

In another embodiment a composite cylindrical bearing 401 shown in FIGS. 8A and 8B has an inner dynamic bearing surface layer 402 and an outer static expansion surface layer 403 of the materials described above. Bearing 501 in FIGS. 9A and 9B is similar to bearing 401 but includes a lantern ring 506 and is formed with an inner reinforcing layer 504. Bearing 401 may also be formed with a lantern ring when desired and a reinforcing layer. Bearings 401 and 501 are suitable for use in rotary and reciprocal applications as described in U.S. Pat. Nos. 6,834,862 and 8,814,432, 9,347,488 and 9,638,251, the entire contents of which are incorporated herein by reference. Bearings 401 and 501 are cylindrical and generally split to facilitate installation over an installed shaft in the mechanical device. In this case, both halves are identical and may be fabricated in the same semi-circular mold place together to form the cylinder. In other embodiments, the generally cylindrical bearings may be split into at least three sections or at least four sections or at least five sections, depending on the size of the shaft of the mechanical device and/or desired usage.

It can readily be seen that the seal system including a cylindrical seal and seal system constructed in accordance with the invention can be easily installed in a conventional rotary impeller pump with pins to guarantee alignment of the seal upon installation. Generally, three packing rings are added to complete installation. When in place, a bearing seal element will support the impeller end of a pump shaft, providing an additional bearing surface to aid in eliminating the whip commonly found in pump shafts. Due to the close tolerances available, improved support of the impeller is assured, resulting in longer life of the main bearings and packing materials as well as reduced wear of the throat of the rotary device. Minimum external leakage also results from the installation of the sealing system constructed and arranged in accordance with the invention.

### Additional Clauses

Clause 1. A composite bearing comprising:
a bearing member having a first static surface layer with a high coefficient of thermal linear expansion (CLTE); and
   an opposed second dynamic surface layer of a bearing grade material having a lower CLTE than the first static surface and harder than the first surface.

Clause 2. The composite bearing member of clause 1, further including;
a strength and reinforcing layer with two opposed faces;
   wherein the first static surface layer is disposed on one face of the reinforcing layer and the second dynamic surface layer is disposed on the opposed face of the reinforcing layer.

Clause 3. A composite bearing member formed of at least three distinct materials comprising:
a reinforcing layer having two faces;
   a static surface layer having a high coefficient of thermal linear expansion (CLTE) disposed on one face of the reinforcing layer; and
   a dynamic surface layer of a material having a lower CLTE than the static layer and harder than the static layer disposed on the opposite surface of the reinforcing layer.

Clause 4. The composite bearing member of any of Clauses 1 to 3, wherein the static surface layer has a CLTE of between about 50 mm/(m·° F.) and about 110 mm/(m·° F.), preferably wherein the static surface layer has a CLTE of between about 70 mm/(m·° F.) and about 95 mm/(m·° F.).

Clause 5. The composite bearing member of any of Clause 1 to 4, wherein the static surface layer is formed of a thermoplastic material selected from the group consisting of polytetrafluoroethylene, a polyfluoroalkyl and mixtures thereof.

Clause 6. The composite bearing member of any of Clauses 1 to 5, wherein the dynamic surface layer has a CLTE of between about 20 mm/(m·° F.) and about 60 mm/(m·° F.), preferably wherein the dynamic surface layer has a CLTE of between about 30 mm/(m·° F.) and about 45 mm/(m·° F.).

Clause 7. The composite bearing member of any of Clauses 1 to 6, wherein the dynamic surface layer is a thermoplastic material selected from the group consisting of polyphenylene sulfides (PPS), polyimidizoles, polyamideimides, polybenzylimidizoles, polyketones, polyaryletherketones, such as polyetheretherketone (PEEK), polytetrafluoroethylene (PTFE), perfluoroalkoxy alkane (PFA), other fluoropolymers and formulations containing these polymers in a major proportion.

Clause 8. The composite bearing member of Clause 1, further comprising a reinforcing layer between the static layer and the dynamic layer.

Clause 9. The composite bearing member of any of Clauses 2 to 8, wherein the reinforcing layer has a CLTE of between 15 mm/(m·° F.) and 45 mm/(m·° F.), preferably wherein the reinforcing layer has a CLTE of between 25 mm/(m·° F.) and 35 mm/(m·° F.).

Clause 10. The composite bearing member of any of Clauses 2 to 9, wherein the reinforcing layer includes a thermoplastic material selected from the group consisting of polyphenylene sulfides (PPS), polyimidizoles, polyamideimides, polybenzylimidizoles, polyketones, polyaryletherketones, such as polyetheretherketone (PEEK), polytetrafluoroethylene (PTFE), perfluoroalkoxy alkane (PFA), other fluoropolymers and formulations containing these polymers in a major proportion.

Clause 11. The composite bearing member of Clause 1, wherein the first static layer and the second dynamic layer are joined together by a material selected from the group consisting of an adhesive, a primer, or other material to bond the first static surface layer to the second dynamic surface layer.

Clause 12. The composite bearing member of Clause 2 or Clause 3, wherein the static layer, the dynamic layer, and the strengthening layer are joined together by applying a material selected from the group consisting of an adhesive, a primer, or other material to a surface of one or more of the first static surface layer, the second dynamic surface layer and the third strengthening layer to bond the layers together.

Clause 13. A method for forming a composite bearing having a first static surface having a high coefficient of thermal linear expansion (CLTE) and a second dynamic surface of a bearing grade material having a lower CLTE than the first layer and harder than the first surface, comprising:
using additive manufacturing to form a substantially rigid unitary cylindrical body having an outside surface having a high CLTE and an inside dynamic surface of a bearing grade material having a lower CLTE than the first layer and harder than the first surface, dimensioned to fit into the annular seal cavity of a rotary mechanical device.

Clause 14. The method of Clause 13, including the step of using additive manufacturing to form a reinforcing layer between the static and dynamic layers.

Clause 15. A method for forming a composite bearing having a first static surface having a high coefficient of thermal linear expansion (CLTE) and a second dynamic surface of a bearing grade material having a lower CLTE than the first layer and harder than the first surface, comprising:
placing one of the materials of high CLTE or lower CLTE in a mold of desired shape and dimension;
placing the other of the materials of high CLTE or lower CLTE on the exposed surface of the other material; and
applying sufficient heat to heat the materials above the softening temperature of the materials; and
applying sufficient pressure to bond the two layers together.

Clause 16. The method of Clause 15, including placing a strength layer material between the static and dynamic layers prior to the step of applying sufficient pressure to bond the layers together.

Clause 17. A method for forming a composite bearing comprising:
using additive manufacturing to form the bearing member having a first static layer with a high coefficient of thermal linear expansion (CLTE); and a second dynamic layer of a bearing grade material having a lower CLTE than the first static surface and harder than the first surface.

Clause 18. A cylindrical composite bearing, comprising a plurality of curved composite bearing member segments of any of Clauses 1 to 12, wherein the plurality of composite bearing segments is aligned together side by side to form a cylinder.

It will thus be seen that the object set forth above, among those made apparent from the preceding description are efficiently attained and, since certain changes may be made in the device set forth without departing from the spirit and scope of the invention, it is intended that all matter contained in the above description and shown in the accompanying drawings shall be interpreted as illustrative and not in a limiting sense.

It is also to be understood that the following claims are intended to cover all the generic and specific features of the invention herein described and all statements of the scope of the invention, which, as a matter of language, may be said to fall there between.

What is claimed is:

1. A composite bearing comprising:
a bearing member having a first static surface layer with a high coefficient of thermal linear expansion (“CLTE”); and
an opposed second dynamic surface layer of a bearing grade material having a lower CLTE than the first static surface and harder than the first surface.

2. The composite bearing member of claim 1, further including;
a strength and reinforcing layer with two opposed faces;
wherein the first static surface layer is disposed on one face of the reinforcing layer and the second dynamic surface layer is disposed on the opposed face of the reinforcing layer.

3. A composite bearing member formed of at least three distinct materials comprising:
a reinforcing layer having two faces;
a static surface layer having a high coefficient of thermal linear expansion (“CLTE”) disposed on one face of the reinforcing layer; and
a dynamic surface layer of a material having a lower CLTE than the static layer and harder than the static layer disposed on the opposite surface of the reinforcing layer.

4. The composite bearing member of claim 1, wherein the static surface layer has a CLTE of between about 50 μm/(m·° F.) and about 110 μm/(m·° F.).

5. The composite bearing member of claim 4, wherein the static surface layer has a CLTE of between about 70 μm/(m·° F.) and about 95 μm/(m·° F.).

6. The composite bearing member of claim 1, wherein the static surface layer is formed of a thermoplastic material selected from the group consisting of polytetrafluoroethylene, a polyfluoroalkyl and mixtures thereof.

7. The composite bearing member of claim 1, wherein the dynamic surface layer has a CLTE of between about 20 μm/(m·° F.) and about 60 μm/(m·° F.).

8. The composite bearing member of claim 1, wherein the dynamic surface layer has a CLTE of between about 30 μm/(m·° F.) and about 45 μm/(m·° F.).

9. The composite bearing member of claim 1, wherein the dynamic surface layer is a thermoplastic material selected from the group consisting of polyphenylene sulfides (PPS), polyimidizoles, polyamideimides, polybenzylimidizoles, polyketones, polyaryletherketones, polytetrafluoroethylene (PTFE), perfluoroalkoxy alkane (PFA), other fluoropolymers and formulations containing these polymers in a major proportion.

10. The composite bearing member of claim 3, wherein the dynamic surface layer has a CLTE of between 20 μm/(m·° F.) and 60 μm/(m·° F.).

11. The composite bearing member of claim 10, wherein the dynamic surface layer has a CLTE of between 30 μm/(m·° F.) and 45 μm/(m·° F.).

12. The composite bearing member of claim 1, further comprising a reinforcing layer between the static layer and the dynamic layer.

13. The composite bearing member of claim 12, wherein the reinforcing layer has a CLTE of between 15 μm/(m·° F.) and 45 μm/(m·° F.).

14. The composite bearing member of claim 13, wherein the reinforcing layer has a CLTE of between 25 μm/(m·° F.) and 35 μm/(m·° F.).

15. The composite bearing member of claim 12, wherein the reinforcing layer includes a thermoplastic material selected from the group consisting of polyphenylene sulfides (PPS), polyimidizoles, polyamideimides, polybenzylimidizoles, polyketones, polyaryletherketones, polytetrafluoroethylene (PTFE), perfluoroalkoxy alkane (PFA), other fluoropolymers and formulations containing these polymers in a major proportion.

16. The composite bearing member of claim 1, wherein the first static layer and the second dynamic layer are joined together by a material selected from the group consisting of an adhesive, a primer, or other material to bond the first static surface layer to the second dynamic surface layer.

17. The composite bearing member of claim 2, wherein the static layer, the dynamic layer, and the strengthening layer are joined together by applying a material selected from the group consisting of an adhesive, a primer, or other material to a surface of one or more of the first static surface layer, the second dynamic surface layer and the third strengthening layer to bond the layers together.

18. A method for forming a composite bearing having a first static surface having a high coefficient of thermal linear expansion (“CLTE”) and a second dynamic surface of a bearing grade material having a lower CLTE than the first layer and harder than the first surface, comprising:
using additive manufacturing to form a substantially rigid unitary cylindrical body having an outside surface having a high coefficient of thermal linear expansion (“CLTE”) and an inside dynamic surface of a bearing grade material having a lower CLTE than the first layer and harder than the first surface, dimensioned to fit into the annular seal cavity of a rotary mechanical device.

19. The method of claim 18, including the step of using additive manufacturing to form a reinforcing layer between the static and dynamic layers.

20. A method for forming a composite bearing having a first static surface having a high coefficient of thermal linear expansion (“CLTE”) and a second dynamic surface of a bearing grade material having a lower CLTE than the first layer and harder than the first surface, comprising:
placing one of the materials of high CLTE or lower CLTE in a mold of desired shape and dimension;
placing the other of the materials of high CLTE or lower CLTE on the exposed surface of the other material; and
applying sufficient heat to heat the materials above the softening temperature of the materials; and
applying sufficient pressure to bond the two layers together.

21. The method of claim 20, including placing a strength layer material between the static and dynamic layers prior to the step of applying sufficient pressure to bond the layers together.

22. A method for forming a composite bearing comprising:
using additive manufacturing to form the bearing member having a first static layer with a high coefficient of thermal linear expansion (“CLTE”); and a second dynamic layer of a bearing grade material having a lower CLTE than the first static surface and harder than the first surface.

23. A cylindrical composite bearing, comprising a plurality of curved composite bearing member segments of claim 1, wherein the plurality of composite bearing segments is aligned together side by side to form a cylinder.
